(19) United States
(12) Patent Application Publication
(10) Pub. No.: US 2006/0250898 A1
(43) Pub. Date: Nov. 9, 2006

(54) Disc position determination methods and related devices

(75) Inventors: Meng-Hsueh Lin, Banqiao City (TW); Hao-Yung Wang, Kaohsiung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/113,697

(22) Filed: Apr. 25, 2005

(51) Int. Cl. H04B 1/20

(52) U.S. Cl. 369/1

(57) ABSTRACT

Disc position determination methods. A disc is divided into parts. The parts are grouped into at least one section. The parts are counted for the section while the disc is read. A disc position is determined according to the counter.

### BACKGROUND

The present disclosure relates generally to disc analysis, and more particularly, to disc position determination and disc measurement methods and related devices.

To ensure the disc writing quality, data must be periodically measured in the recorded area of a disc. These disc measurement are well known, such as jitter, beta and gamma measurements. Regardless of the measurement, however, a critical pre-step is to accurately locate the previous area recorded, or the subsequent measurement will be incorrect and meaningless.

Data for writing to discs without pre-planned data addresses, such as DVD-R, is written in sequence. The position to be measured can be obtained according to the position information generated while recording. Data for writing to discs with pre-planned data addresses, such as DVD-RAM (DVD Rewritable Disk), however, is not written in sequence. In a disc, respective sectors are separated by headers, and data can be randomly written to any sector thereof. Since no position information is provided, there is no way to determine the disc position.

### SUMMARY

Disc position determination and disc measurement methods, and related devices, are provided. In an exemplary embodiment of a disc position determination method, a disc is divided into parts. The parts are grouped into at least one section. The parts are counted for the section while the disc is read. A disc position is determined according to the counter.

In another exemplary embodiment of a disc measurement method, a disc is divided into parts. The parts are grouped into at least one section. The parts are counted for the section while the disc is read. A disc position is determined according to the counter. A disc measurement is performed on the disc position.

Disc position determination and disc measurement methods may take the form of program code embodied in a tangible media. When the program code is loaded into and executed by a machine, the machine becomes an apparatus for practicing the disclosed method.

### DESCRIPTION OF THE DRAWINGS

Disc position determination and disc measurement methods and related devices will become more fully understood by referring to the following detailed description with reference to the accompanying drawings, wherein:

FIG. 1 is a schematic diagram illustrating an embodiment of a device for disc position determination;

FIG. 2 is a schematic diagram illustrating an embodiment of an adjustment unit;

FIG. 3 is a flowchart of an embodiment of a disc position determination method;

FIG. 4 shows a DVD-RAM format;

FIG. 5 shows a header field in the DVD-RAM format;

FIG. 6 is a schematic diagram illustrating an embodiment of a device for disc measurement; and

FIG. 7 is a flowchart of an embodiment of a disc measurement method.

### DESCRIPTION

Disc position determination and disc measurement methods and related devices are provided.

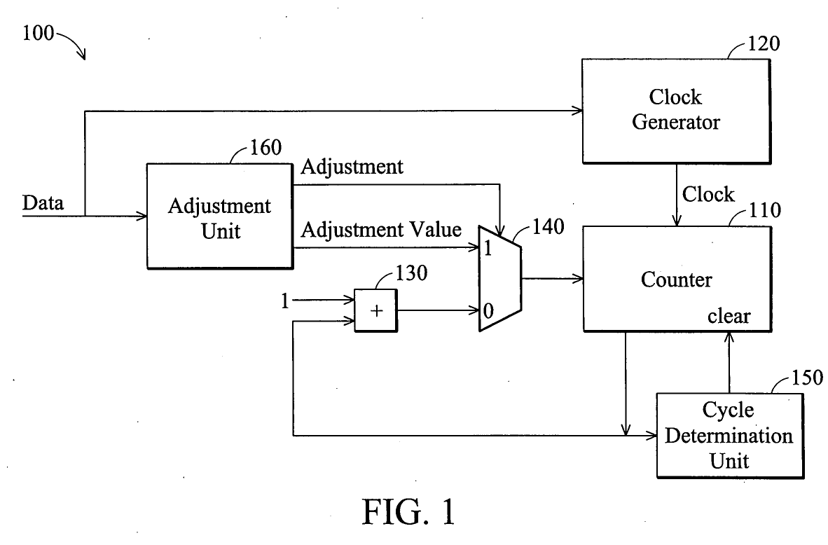

FIG. 1 is a schematic diagram illustrating an embodiment of a device for disc position determination.

The device 100 comprises a counter 110, a clock generator 120, an adder 130, a multiplexer 140, a cycle determination unit 150, and an adjustment unit 160. In the invention, a disc is divided into parts. The parts are grouped into at least one section. It is understood that the disc is divided and the parts are grouped based on a disc format. Additionally, a start position within the parts is assigned for the section. The counter 110 is reset when the start position is read.

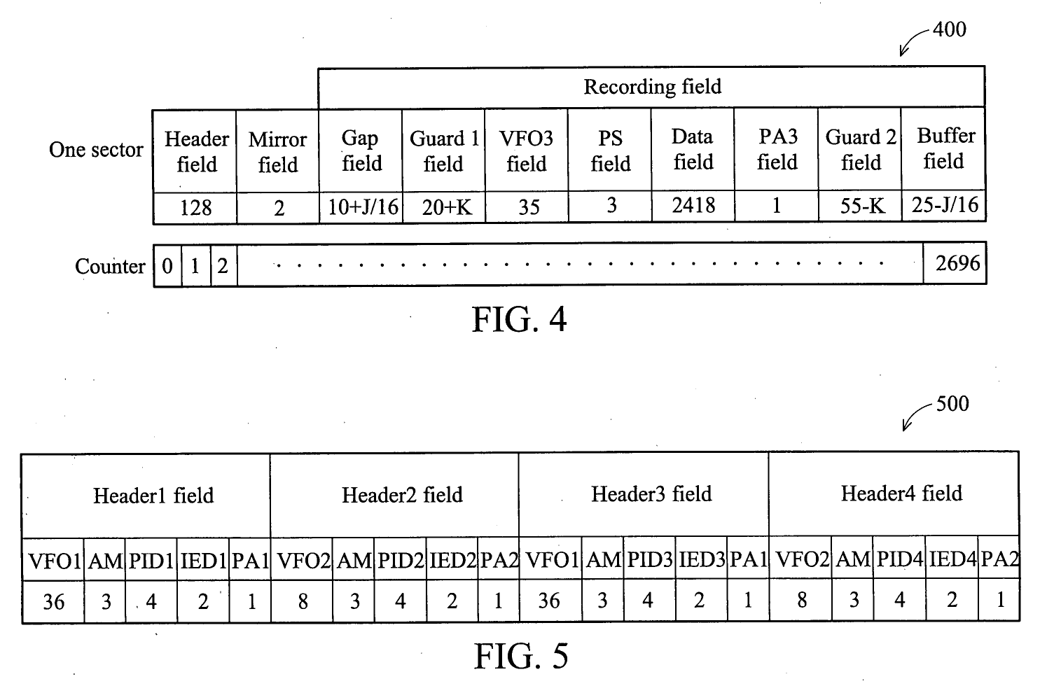

For example, a DVD-RAM format is illustrated in FIG. 4. A DVD-RAM disc has a plurality of sectors, each has 2697 bytes. In some embodiments, a respective sector is divided into 2697 parts, and designated as a section. As shown in FIG. 4, a sector has a header field, a mirror field, and a recording field. The header field in the DVD-RAM format is assigned as the start position for the section.

The counter 110 counts the parts of a section while a disc is read, such as 0˜2696 for respective sectors in a DVD-RAM disc. The clock generator 120 generates clocks based on disc physical properties, such as EFM (Eight to Fourteen Modulation) signals or wobble signals read from the disc. For example, since a respective part of a DVD-RAM disc is 16T (channel bits), the clock generator 120 generates a clock period per 16T according to the wobble signals. In response to the clock from the clock generator 120, the counter 110 adds one by way of the adder 130 and the multiplexer 140. The cycle determination unit 150 checks whether the counter 110 equals a counting cycle, such as 2697 in DVD-RAM discs. If so, the cycle determination unit 150 clears the counter 110, such that the counter 110 recounts the parts for another section. The disc position is determined according to the counter 110.

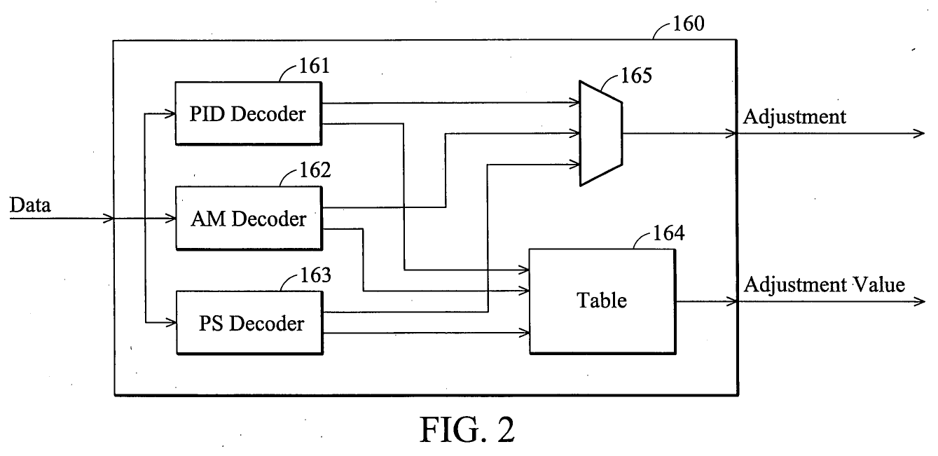

The adjustment unit 160 adjusts the counter 110 based on a position corresponding to a specific part in the section if the specific part is read. FIG. 2 is a schematic diagram illustrating an embodiment of an adjustment unit. The adjustment unit 160 comprises a PID (Physical Identification) decoder 161, an AM (Address Mark) decoder 162, a PS (Pre-Synchronous code) decoder 163, a table 164, and a multiplexer 165. In the DVD-RAM format, a PID and AM fields in the header field, and a PS filed in the recording field have specific corresponding patterns. The decoders (161, 162 and 163) decode the data read from the disc, and determines whether it corresponds to any of the specific patterns.

For example, the PID field is read if a PID pattern is recognized, the AM field is read if an AM pattern is recognized, and the PS field is read if a PS pattern is recognized. It is understood that several PID fields (PID1, PID2, PID3 and PID4), and AM fields are contained in the header field 500 of the DVD-RAM format, as shown in FIG. 5. The corresponding positions for respective fields are stored in the table 164. For example, the position for the PID1 field is 42, and the position for the AM field in the header 2 field is 56, and others. If a specific pattern matches, the multiplexer 165 gene rates an adjustment instruction to the multiplexer 140 to enable the adjustment of the counter 110. Further, the position corresponding to the matched field is retrieved from the table 164, and transmitted to the multiplexer 140, such that the counter 110 is adjusted according to the position. It is also understood that other fields in the DVD-RAM format may be used for counter adjustment.

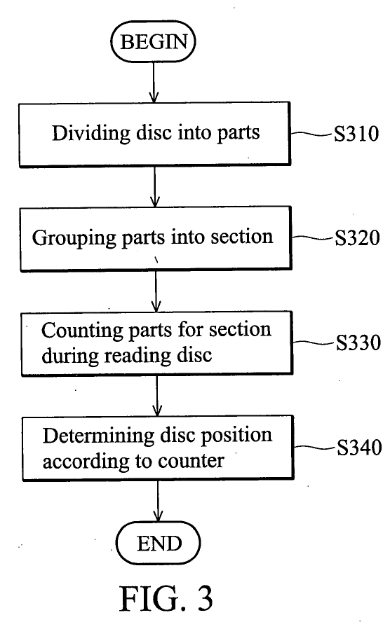

FIG. 3 is a flowchart of an embodiment of a disc position determination method.

First, in step S310, a disc is divided into parts, and in step S320, the parts are grouped into sections. The disc is divided and the parts are grouped based on a disc format. In step S330, the parts are counted for the section while the disc is read. The counter is based on disc physical properties, such as EFM (Eight to Fourteen Modulation) signals or wobble signals read from the disc, and the counter recounts for respective sections. In step S340, a disc position is determined according to the counter and the disc format. For example, if the counter is 114,

It is understood that the counter is further adjusted based on a position corresponding to a specific part in the section if the specific part is read.

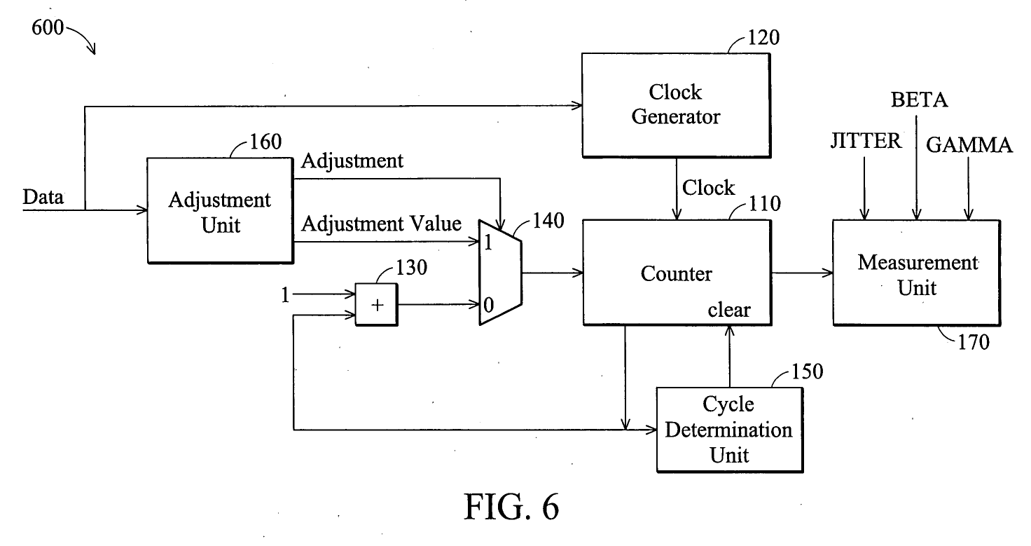

FIG. 6 is a schematic diagram illustrating an embodiment of a device for disc measurement. In addition to the components, the device 600 for disc measurement comprises a measurement unit 170. The measurement unit 170 receives instructions for a disc measurement on a specific disc position. The disc measurement comprises jitter, beta, gamma measurement, and others. Once the specific disc position is reached based on the counter, the measurement unit 170 performs the disc measurement thereon.

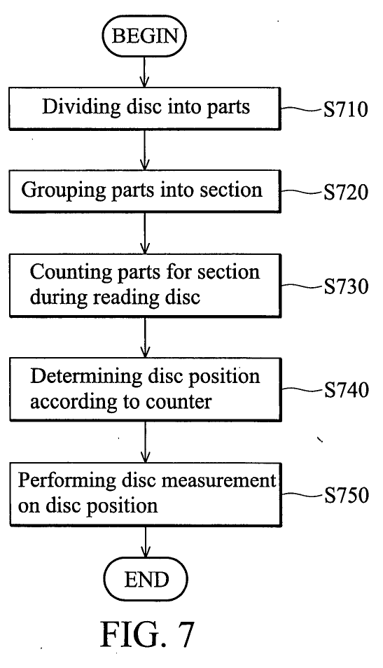

FIG. 7 is a flowchart of an embodiment of a disc measurement method.

First, in step S710, a disc is divided into parts, and in step S720, the parts are grouped into sections. The disc is divided and the parts are grouped based on a disc format. In step S730, the parts are counted for the section while the disc is read. The counter is based on disc physical properties, such as EFM (Eight to Fourteen Modulation) signals or wobble signals read from the disc, and the counter recounts for respective sections. In step S740, a disc position is determined according to the counter and the disc format. It is understood that the counter is further adjusted based on a position corresponding to a specific part in the section if the specific part is read. Once the disc position is determined, in step S750, a disc measurement is performed on the disc position.

Disc position determination and disc measurement methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer or a device comprising a mobile phone, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer or a device comprising a mobile phone, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A disc position determination method, comprising:
dividing a disc into parts;
grouping the parts into at least one section;
counting the parts for the section while reading the disc; and
determining a disc position according to the counter.

2. The method of claim 1 further comprising dividing the disc based on a disc format.

3. The method of claim 1 further comprising grouping the parts based on a disc format.

4. The method of claim 1 further comprising assigning a start position within the parts for the section, and resetting the counter when the start position is read.

5. The method of claim 4 further comprising assigning the start position as a header in a disc format.

6. The method of claim 1 further comprising counting the parts based on disc physical properties.

7. The method of claim 6 wherein the disc physical properties comprise EFM (Eight to Fourteen Modulation) signals or wobble signals.

8. The method of claim 1 further comprising adjusting the counter based on a position corresponding to a specific part in the section if the specific part is read.

9. The method of claim 8 further comprising adjusting the counter according to the position corresponding to a PID (Physical Identification) or AM (Address Mark) field in a header field of a DVD-RAM format if the PID or AM field is read.

10. The method of claim 8 further comprising adjusting the counter according to the position corresponding to a PS (Pre-Synchronous code) field in a recording field of a DVD-RAM format if the PS field is read.

11. The method of claim 1 wherein the disc comprises a DVD-RAM, and the section comprises a sector comprising 2697 bytes, each divided into one of the parts.

12. A device, comprising:
means for dividing a disc into parts;
means for grouping the parts into at least one section;
means for counting the parts for the section while reading the disc; and
means for determining a disc position according to the counter.

13. The device of claim 12 wherein the device comprises a disc drive.

14. A machine-readable storage medium comprising a program, which, when executed, causes a device to perform a disc position determination method, the method comprising:
dividing a disc into parts;
grouping the parts into at least one section;
counting the parts for the section while reading the disc; and
determining a disc position according to the counter.

15. A disc measurement method, comprising:
dividing a disc into parts;
grouping the parts into at least one section;
counting the parts for the section while reading the disc;
determining a disc position according to the counter; and
performing a disc measurement on the disc position.

16. The method of claim 15 wherein the disc measurement comprises a jitter, beta, or gamma measurement.

17. The method of claim 16 further comprising adjusting the counter according to the position corresponding to a PID (Physical Identification) or AM (Address Mark) field in a header field of a DVD-RAM format if the PID or AM field is read.

18. The method of claim 17 further comprising adjusting the counter according to the position corresponding to a PS (Pre-Synchronous code) field in a recording field of a DVD-RAM format if the PS field is read.

19. A device, comprising:
means for dividing a disc into parts;
means for grouping the parts into at least one section;
means for counting the parts for the section while reading the disc;
means for determining a disc position according to the counter; and
means for performing a disc measurement on the disc position.

20. The device of claim 19 wherein the device comprises a disc drive.
